(19) United States
(12) Patent Application Publication
(10) Pub. No.: US 2005/0033939 A1
(43) Pub. Date: Feb. 10, 2005

(54) Address generation

(75) Inventor: Wilco Dijkstra, Cambridge (GB)

Correspondence Address: NIXON & VANDERHYE, PC, 1100 N GLEBE ROAD, 8TH FLOOR, ARLINGTON, VA, 22201-4714, US

(73) Assignee: ARM Limited, Cambridge (GB)

(21) Appl. No.: 10/633,362

(22) Filed: Aug. 4, 2003

(51) Int. Cl. G06F 9/30

(52) U.S. Cl. 712/205; 712/225

(57) ABSTRACT

The present invention relates to address generation and in particular to address generation in a data processing apparatus. A data processing apparatus is disclosed. The data processing apparatus comprises: a processor core operable to process a sequence of instructions, the processor core having a plurality of pipeline stages, one of the plurality of pipeline stages being an address generation stage operable to generate an address associated with an instruction for subsequent processing by the pipeline stages, the instruction being one from a first group of instructions or a second group of instructions. The address generation stage comprises: address generation logic operable to receive operands associated with the instruction, to generate a shifted operand from one of the operands, and to add together, in dependence on the instruction, selected of the operands and the shifted operand to generate the address for subsequent processing by the pipeline stages; and operand routing logic operable, in dependence on the instruction, to route operands associated with instructions from the first group of instructions to the address generation logic and to route operands associated with instructions from the second group of instructions via operand manipulation logic for manipulation of the operands prior to routing to the address generation logic. Accordingly, addition instructions as well as a shift instruction are processed more quickly than other instructions. Because the addition instructions and the shift instruction occur more frequently than the other instructions, the overall performance of the pipeline is significantly improved.

### BACKGROUND OF THE INVENTION

1. Field of the Invention

The present invention relates to address generation and in particular to address generation in a data processing apparatus.

2. Description of the Prior Art

Address generators for data processing apparatus are known. One such data processing apparatus is shown in FIG. 1. The data processing apparatus, generally 5, comprises a processor core 10 arranged to process instructions received from a memory 20 via a bus interface unit (BIU) 50. Data required by the processor core 10 for processing those instructions may also be retrieved from the memory 20 via the BIU 50. A cache 30 is provided for storing data values (which may be data and/or instructions) retrieved from the memory 20 so that they are subsequently readily accessible by the processor core 10. A cache controller 40 controls the storage of data values in the cache 30 and controls the retrieval of the data values from the cache 30.

The processor core 10 is a pipelined processor which enables multiple instructions to be in the process of being executed at the same time. Rather than having to wait until the execution of one instruction has fully completed before providing the next instruction to the processor core 10, a pipelined processor is able to receive new instructions into the pipeline whilst other instructions are still in the process of being executed at subsequent pipeline stages of the pipeline, thereby significantly improving performance.

To further improve the performance of pipelined processors, it is known to provide the processor core 10 with multiple pipelines, as illustrated in FIG. 2, rather than just a single pipeline. As shown, a pipeline may be provided for dealing with load and store instructions, whilst a different pipeline may be provided for dealing with arithmetic instructions. Typically, the first part of each pipeline is unified such that there is a common pipeline for the earlier stages of instruction execution, such as the fetch and decode stages 60, 70. Thereafter, the pipeline splits with arithmetic instructions being executed by one or more first execution stages 80 and load and store instructions being executed by a second execution stage 90 and then one or more memory stages 100. The pipelines may then become unified again for the last stage of instruction execution at the write-back stage 110.

It will be appreciated that the speed at which the processor core 10 can run is limited ultimately by the critical path of instructions through the various stages. The time taken to execute operations on the critical path will affect the speed at which the processor core 10 can run. Due to the relatively slow access time, instructions causing memory accesses will invariably be on the critical path. Hence, any techniques to reduce the access time such as reducing the time taken to generate the address for memory accesses will usually enable the processor core 10 to be run more quickly. The memory address required for such accesses are generated by the second execution stage 90. Accordingly, to further improve the performance of the pipelined processor, the second execution stage 90 is optimised for memory address generation for loads and stores to the cache 30.

The processor instruction set may define a number of different instructions that can be used to generate such loads and stores. Typically, in ARM (trademark) architectures, five different load (and corresponding store) instructions are supported. The load instructions comprise:
a) LDR Ra, [Rb, #I] (i.e. load into the register Ra the value stored in the memory address referred to by adding the immediate ‘I’ to the contents of the register Rb; the immediate ‘I’ may be a positive or negative integer);
b) LDR Ra, [Rb, Rc] (i.e. load into the register Ra the value stored in the memory address referred to by adding the contents of the register Rb to the contents of the register Rc);
c) LDR Ra, [Rb, −Rc] (i.e. load into the register Ra the value stored in the memory address referred to by subtracting the contents of the register Rc from the contents of the register Rb);
d) LDR Ra, [Rb, Rc, LSL/R#N] (i.e. load into the register Ra the value stored in the memory address referred to by adding the contents of the register Rb to the contents of the register Rc when subjected to a logical shift left/right by N bits); and
e) LDR Ra, [Rb, −Rc, LSL/R#N] (i.e. load into the register Ra the value stored in the memory address referred to by subtracting the contents of the register Rc when subjected to a logical shift left/right by N bits from the contents of the register Rb).

As mentioned above, five corresponding store instructions are also supported.

Hence, it will be appreciated that the second execution stage 90 is required to support both addition and shift operations for positive and negative operands. It will also be appreciated that shift operations provide a convenient mechanism when it is desired to perform, for example, a multiplication operation on the contents of the Rc register.

Accordingly, as illustrated by FIGS. 3A and 3B, a prior art address generator 120 in the second execution stage 90 incorporated a combined adder and shift function.

Typically, a value such as the immediate ‘I’ or the contents of the register Rc are provided on the X input. From this X input, the value of the X input (X) and the inverse of the X input (\overline{X}) are provided to a multiplexer 130. Also, the X input logically shifted a number of bits left or right (X_{LSL/R(#1-N)}) is generated by a shifter 135 and the inverse of the X input logically shifted a number of bits left or right (\overline{X_{LSL/R(#1-N)}}) is also provided by an inverter to the multiplexer 130. Typically, where the operands are, for example, 32 bit, the X input may be shifted by any number from 1 to 31 bits left or right in order to generate the (X_{LSL/R(#1-N)}) output. On the Y input, the contents of the Rb register are typically provided to an A input of an adder 140.

The multiplexer 130 selects one of the inputs to be provided to the B input of the adder 140 dependent on the instruction. The adder 140 then adds together the contents provided on the A and B inputs and generates the output A+B. It will be appreciated that for addition operations the carry input C will be set to a logical ‘0’, whereas for subtraction operations the carry input C will be set to a logical ‘1’. Through this approach the address generator 120 can provide the functionality to support all the instructions mentioned above.

However, it was found that providing this degree of functionality within this stage of the pipeline meant that the time taken for this stage to process the instruction was relatively long which, because this stage is on the critical path, limited the speed at which instructions could be clocked through the pipeline. The reason that the execution speed of this address generator 120 was relatively slow was due to the time taken by the shifter 135 to generate the (X_{LSL/R(#1-N)}) and (\overline{X_{LSL/R(#1-N)}}) operands.

To address this problem, a subsequent arrangement of address generator 150 split the adder and shift functions into two different logic units 160, 170, as illustrated by FIG. 4.

Any shift operation is performed by the shifter 135 in the shift logic unit 160 prior to the add operation. Hence, the output provided by the shift logic unit 160 may be the X input (i.e. X) or the X input shifted left or right by any number of bits (i.e. X_{LSL/R(#1-N)}), dependent on the selection made by the multiplexer 137. The adder logic unit 170 retains the functionality to provide the inverse of an operand, dependent on the selection made by the multiplexer 130. Hence, the adder is still able to receive on input B, the X input, the inverse of the X input (\overline{X}), the X input logically shifted a number of bits left or right (X_{LSL/R(#1-N)}) and the inverse of the X input logically shifted a number of bits left or right (\overline{X_{LSL/R(#1-N)}})

By separating these functions, the time taken for each logic unit 160, 170 to process instructions is reduced. Hence, the speed at which instructions can be clocked through the address generation stage 150 is increased. Typically, each logic unit 160, 170 was found to take about half the time to process instructions as the arrangement in FIGS. 3A and 3B. Accordingly, the speed at which instructions are clocked through the pipeline could be increased by about a factor of two.

However, it will be appreciated that a problem with this arrangement is that all instructions must be routed through both the shift and adder logic units 160, 170, irrespective of whether a shift operation is to be performed or not.

Accordingly, to address this problem a further address generator arrangement was devised as illustrated in FIG. 5.

In this arrangement only those instructions which require a shift operation are routed by multiplexers 155, 165 through the shift logic unit 160, with all other non-shift instructions being routed by multiplexers 155, 165 directly to the adder logic unit 170.

Accordingly, the time taken to process shift instructions remains unchanged in comparison with the arrangement in FIG. 4 since these instructions are still routed through both the shift and adder logic units 160, 170. However, the time taken by the address generator 180 to process non-shift instructions is significantly reduced in comparison with the prior arrangements since these instructions need not be routed through the shift logic unit 160, which takes additional clock cycles, but may instead by processed directly by the adder logic unit 170. It will be appreciated that such an approach can increase the overall performance of the processor core 10 when shift operations occur infrequently.

It is desired to further increase the performance of the processor core 10 when processing instructions.

### SUMMARY OF THE INVENTION

According to a first aspect, the present invention provides a data processing apparatus comprising: a processor core operable to process a sequence of instructions, the processor core having a plurality of pipeline stages, one of the plurality of pipeline stages being an address generation stage operable to generate an address associated with an instruction for subsequent processing by the pipeline stages, the instruction being one from a first group of instructions or a second group of instructions, the address generation stage comprising: address generation logic operable to receive operands associated with the instruction, to generate a shifted operand from one of the operands, and to add together, in dependence on the instruction, selected of the operands and the shifted operand to generate the address for subsequent processing by the pipeline stages; and operand routing logic operable, in dependence on the instruction, to route operands associated with instructions from the first group of instructions to the address generation logic and to route operands associated with instructions from the second group of instructions via operand manipulation logic for manipulation of the operands prior to routing to the address generation logic.

The present invention recognises that during typical processing of instructions by the data processing apparatus, the occurrence of instructions which require one particular shift operation from the set of all possible shift operations has been found to be almost equally as high as those which do not require that shift operation. Accordingly, address generation logic is provided which can perform both that particular shift operation, when required, as well as an addition operation on the operands of instructions. Providing address generation logic which can perform the shift operation as well as an addition operation enables both of these operations to be performed by the same logic without the need to always pass those instructions to other logic for handling, such as previously occurred for those instructions requiring the shift operation. It will be appreciated that because instructions requiring the shift operation do not need to be passed to other logic for handling, the time taken to process these instructions is significantly reduced and, hence, the performance of the pipelined processor when processing such instructions is significantly increased.

The present invention also recognises that the processing speed of the address generation logic can be limited by the speed of the logic which selects between the operands in order to generate the address. Hence, in order to prevent the operating speed of the address generation logic from increasing, the further functionality required to perform the shift operation cannot simply be added to the existing functionality of the prior art adder logic since this would slow the operation of this logic. Hence, so as to not slow the operation of the address generation logic, the logic previously provided to generate inverse operands is removed and replaced with the logic required to support the shift operation. Because the time taken to generate just one particular shift operand from an operand associated with the instruction is relatively small, the address generation logic may always perform this shift operation without increasing the time taken by the address generation stage. The address generation logic may then select the appropriate combination of original operands or shifted operand for addition dependent on the instruction to be performed. Also, because the number of operands to be selected by the address generation logic has not increased, no increase in the time taken to select between operands occurs.

The operand manipulation logic may be provided separately and only those instructions which require this functionality are routed through this logic. It will be appreciated that routing instructions through this separate logic increases the time taken by the address generation stage to generate the address for these instructions. However, the present invention further recognises that the occurrence of instructions which need to be routed via the operand manipulation logic is relatively low in comparison to instructions which require the shift and additive operations. Accordingly, not only is the overall performance of the address generation stage not impacted by the provision of separate operand manipulation logic, the performance is in fact significantly increased because the most frequently occurring shift operation can now be dealt with directly by the address generation logic without the need to incur the performance hit of routing these instructions to separate logic to deal with shift operations.

Hence, it will be appreciated that the overall performance of the address generation stage is increased because the address generation logic has been optimised to handle only those most frequently occurring instructions. By only handling the most common shift operation and addition operations, the functionality required to be provided by the address generation logic can be minimised which, in turn, maximises the speed at which that this logic can operate.

In one embodiment, the instruction relates to a memory access and the address indicates a location in memory to be accessed.

Hence, it will be appreciated that this arrangement is particularly suited to the processing of instructions which generate locations in a memory associated with the data processing apparatus to be accessed.

In one embodiment, the first group of instructions comprises a first instruction which causes the processor core to logically add together two operands, and a second instruction which causes the processor core to logically add together one operand to another operand logically shifted by one of a predetermined number of bits.

In one embodiment, the address generation logic is operable to generate the another operand logically shifted by one of a predetermined number of bits.

Hence, the address generation logic can generate addresses for those instructions which require an addition of the two operands associated with the instruction or can generate addresses for those instructions which require one operand to be added to another operand which is shifted by a preset particular number of bits.

In one embodiment, the second instruction causes the processor core to logically add together one operand to another operand logically shifted left by two bits.

The logical shift left by two bits operation has been found typically to be the most commonly-occurring shift operation.

In one embodiment, the address generation logic is operable to generate the another operand logically shifted left by two bits.

Hence, the address generation logic is optimized to handle the most frequently occurring shift instruction which requires the operand to be logically shifted left by two bits.

In one embodiment, the second instruction causes the processor core to logically add together one operand to another operand subject to only one preset logical shift operation.

By limiting the functionality of the address generation logic to handle an instruction requires just one preset logical shift operation, the size of the logic can be reduced such that it can operate at high speed.

In one embodiment, the address generation logic is operable to perform only one predetermined logical shift operation and operands associated with all other logical shift operations required by instructions from said second group of instructions are routed via operand manipulation logic for manipulation of operands prior to routing to the address generation logic.

Hence, all instructions other than instructions for which the address generation logic is optimized are passed to the operand manipulation logic. The operand manipulation logic may then generate the necessary operands in a form that is suitable for handling in an optimized way by the address generation logic.

In one embodiment, the second group of instructions comprises instructions which cause the processor core to logically add together one operand to another operand subject to any other logical shift operation.

In one embodiment, the operand manipulation logic is operable, in dependence on the instruction, to generate the another operand logically shifted by any other number of bits.

Hence, the operand manipulation logic can generate an operand shifted by any number of bits which can then be supplied to the address generation logic. Although generating these shifted operands can take a relatively long amount of time, because the frequency at which such operands are generated is relatively low, the overall performance of the address generation stage still remains significantly higher than prior art arrangements.

In one embodiment, the second group of instructions comprises instructions which cause the processor core to logically subtract one operand from another operand.

In one embodiment, the operand manipulation logic is operable, in dependence on the instruction, to generate an inverse representation of one of the operand and the another operand.

Hence, the operand manipulation logic can generate an inverse operand which can then be supplied to the address generation logic. Although passing operands to the operand manipulation logic to generate these inverse operands can take a relatively long amount of time, because the frequency at which such operands are generated is relatively low, the overall performance of the address generation stage still remains significantly higher than prior art arrangements.

In one embodiment, the second group of instructions comprises a subtractive instruction for which the address is generated by subtracting a subtrahend operand from a minuend operand associated with the instruction, and the operand manipulation logic comprises subtraction operand generation logic operable to generate a negative representation of the subtrahend operand prior to routing to the address generation logic.

Hence, in such embodiments, the logic that was previously provided in the address generation logic to support subtraction operations is removed and replaced with logic required to support shift operations, and the subtraction operand generation logic is provided separately. Only instructions which involve a subtraction need by routed through this separate logic. Whilst routing instructions through this separate logic increases the time taken by the address generation stage to generate the address, it has been found that the occurrence of instructions involving a subtraction is relatively low in comparison to instructions which require a shift and additive operation. Accordingly, as mentioned above, not only is the overall performance of the address generation logic not impacted by the provision of separate subtraction operand generation logic, the performance is in fact significantly increased because the more frequently occurring shift operation can now be dealt with directly by the address generation logic without needing to be delayed due to routing these instructions through separate logic to deal with the shift operation.

In one embodiment, the address generation logic comprises: operand generation logic operable to receive a first operand associated with the instruction and to generate a shifted operand representative of the first operand shifted by a predetermined number of bits; operand selection logic operable, in dependence on the instruction, to select one of the first operand and the shifted operand as a selected operand; and addition logic operable to add a second operand associated with the instruction to the selected operand to generate the address for subsequent processing by the pipelined stages.

In such embodiments, the address generation logic receives a number of operands associated with the instruction. For instructions in the first group of instructions, these operands may be those operands which are the subject of the instruction. For instructions in the second group of instructions these operands may be one or more operands which are the subject of the instruction in addition to any operands which may be generated by the operand manipulation logic. The operand manipulation logic receives one of these operands and performs the shift operation by generating a shifted operand. Operand selection logic then selects either the first operand or the shifted operand to supply to the addition logic. The decision of which of the first operand or the scalar operand to select is made based on the instruction itself. The addition logic then receives the operand from the operand selection logic and adds this to a second operand to generate the required address.

In one embodiment, the first operand comprises ‘n’-bits, where ‘n’ is a positive integer, the operand generation logic receives the first operand over an ‘n’-bit input bus and provides the shifted operand on an ‘n’-bit output bus, the operand generation logic comprising: interconnection logic operable to couple lines of the ‘n’-bit input bus with lines of the ‘n’-bit output bus to perform the shift operation.

Hence, the shift operation can be performed by hard-wiring the bus to present the bits of the operand in a new order. It will be appreciated that such an approach is fast and ensures that no undue delay is introduced in the address generation stage.

In one embodiment, the operand selection logic is a two-input multiplexer.

By providing two inputs to the operand selection logic, the operating speed of this logic is maintained.

In one embodiment, the operand selection logic is operable to select one of the first operand and the shifted operand as a selected operand in response to a selection signal generated by instruction decoder logic.

The instruction decoder logic is typically provided in an earlier decode stage of the pipeline. This logic typically generates a number of control signals, in dependence on the instruction being processed, for use by the pipeline and other elements of the data processing apparatus. One such control signal may be a selection signal which is used by the operand selection logic to ensure that the correct operands are selected during the address generation stage. By using pre-generated signals during this selection, it will be appreciated that no undue delay is introduced at address generation stage which may otherwise occur should a determination need to be made by that stage regarding which operands to select.

In one embodiment, the addition logic is a two operand adder.

In one embodiment, the operand routing logic is operable to route operands in response to a routing signal generated by instruction decoder logic.

As mentioned above, the instruction decoder logic is typically provided in an earlier decode stage of the pipeline and generates a number of control signals, in dependence on the instruction being processed. One such control signal may be a routing signal which is used by the operand routing logic to ensure that the operands are routed either directly to the address generation logic, or via the operand manipulation logic. By using pre-generated signals during this routing, it will be appreciated that no undue delay is introduced at the address generation stage which may otherwise occur should a determination need to be made by that stage regarding which logic to select.

In one embodiment, the instruction is a subtraction instruction which causes the processor core to generate the address by subtracting a subtrahend operand in the form of an immediate from a minuend operand, and the data processing apparatus comprises instruction decoder logic operable to provide the subtrahend operand in negative form to the address generation stage and to generate a routing signal to cause the operand routing logic to route operands to the address generation logic.

As mentioned above, the instruction decoder logic is typically provided in an earlier decode stage of the pipeline. During this stage a number of operations typically need to be performed when decoding the instruction. It has been found that it is possible to generate immediates in positive or negative form in parallel with the instruction decoding without increasing the time taken by that stage. Accordingly, such negative immediates can be generated by the decode logic and provided in the negative form to the address generation stage. Because the immediate is already in negative form, there is no need to invoke the operand manipulation logic. Accordingly, instructions utilising negative immediates can be treated as additive instructions and the negative immediate can be routed directly to the address generation logic. It will be appreciated that this further improves the performance of the address generation stage.

In one embodiment, the instruction is one of a load instruction and a store instruction.

According to a second aspect of the present invention there is provided in a data processing apparatus comprising a processor core operable to process a sequence of instructions, the processor core having a plurality of pipeline stages, one of the plurality of pipeline stages being an address generation stage operable to generate an address associated with an instruction for subsequent processing by the pipeline stages, the instruction being one from a first group of instructions or a second group of instructions, a method of generating the address comprising the steps of: receiving, at address generation logic, operands associated with the instruction; generating a shifted operand from one of the operands; adding together, in dependence on the instruction, selected of the operands and the shifted operand to generate the address for subsequent processing by the pipeline stages; routing, in dependence on the instruction, operands associated with instructions from the first group of instructions to the address generation logic; and routing, in dependence on the instruction, operands associated with instructions from the second group of instructions via operand manipulation logic for manipulation of the operands prior to routing to the address generation logic.

### BRIEF DESCRIPTION OF THE DRAWINGS

The present invention will be described further, by way of example only, with reference to a preferred embodiment thereof as illustrated in the accompanying drawings, in which:

FIG. 1 illustrates elements of a data processing apparatus;

FIG. 2 illustrates an example arrangement of pipeline stages in a pipelined processor;

FIGS. 3A and 3B illustrate a prior art arrangement of one stage in the pipelined processor;

FIG. 4 illustrates a subsequent prior art arrangement of one stage in the pipelined processor,

FIG. 5 illustrates a yet further prior art arrangement of one stage in the pipelined processor,

FIGS. 6A and 6B illustrate an arrangement of one stage in the pipelined processor according to an embodiment of the present invention; and

FIG. 7 illustrates elements of a decode stage.

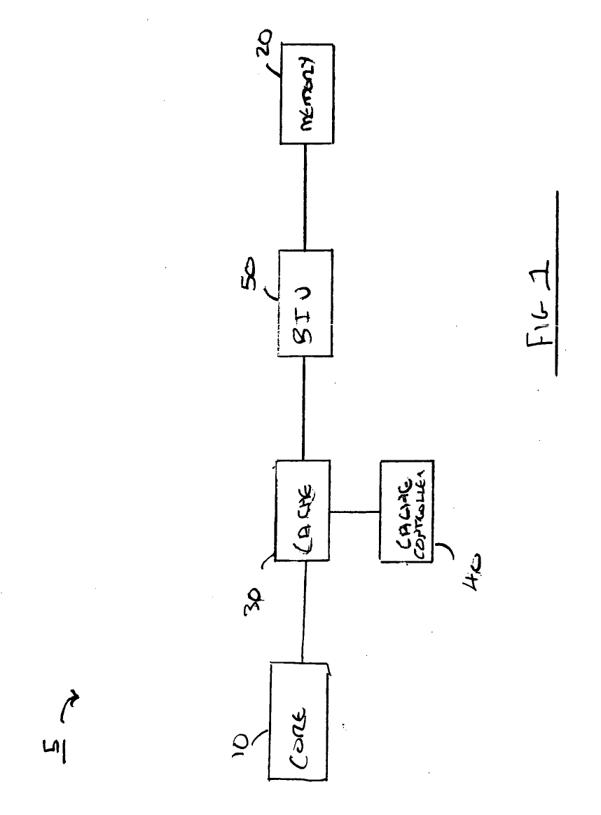

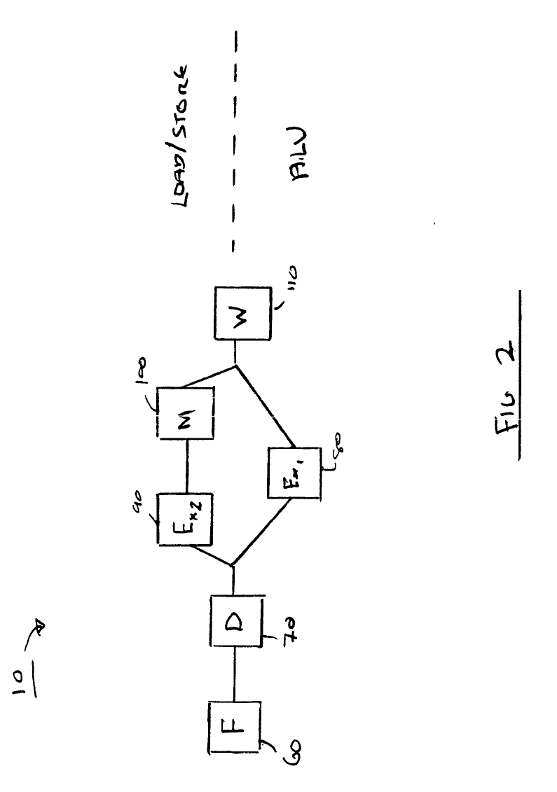

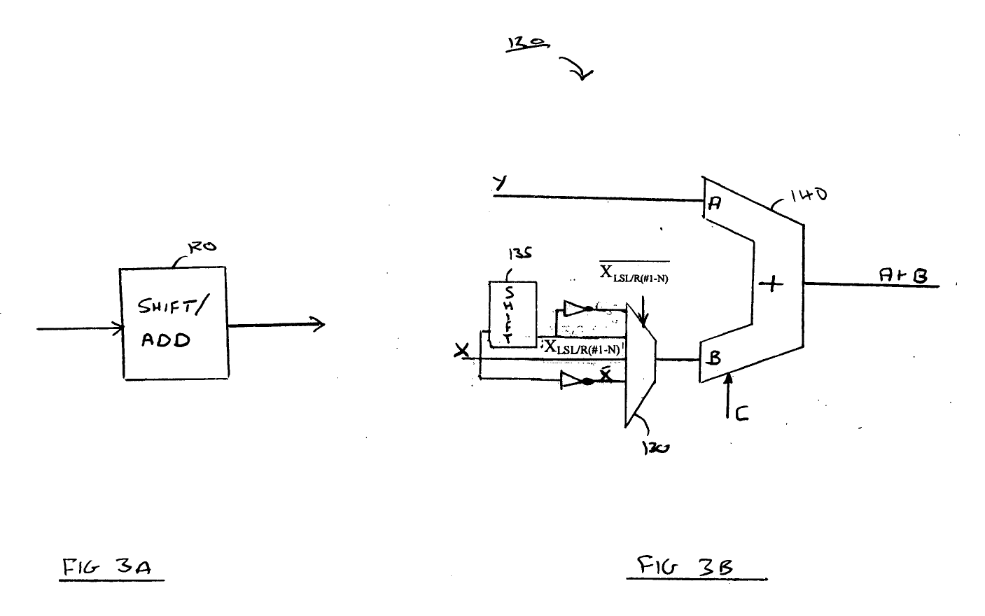

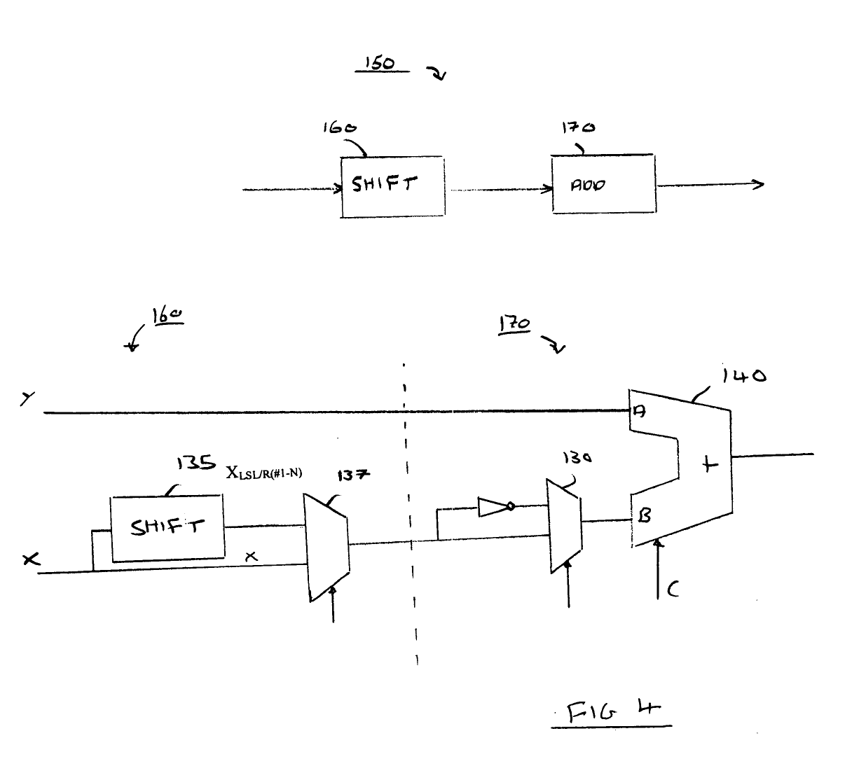

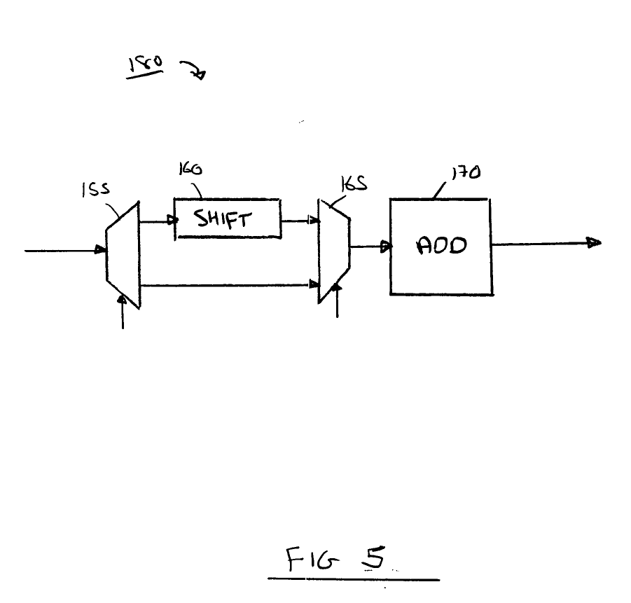

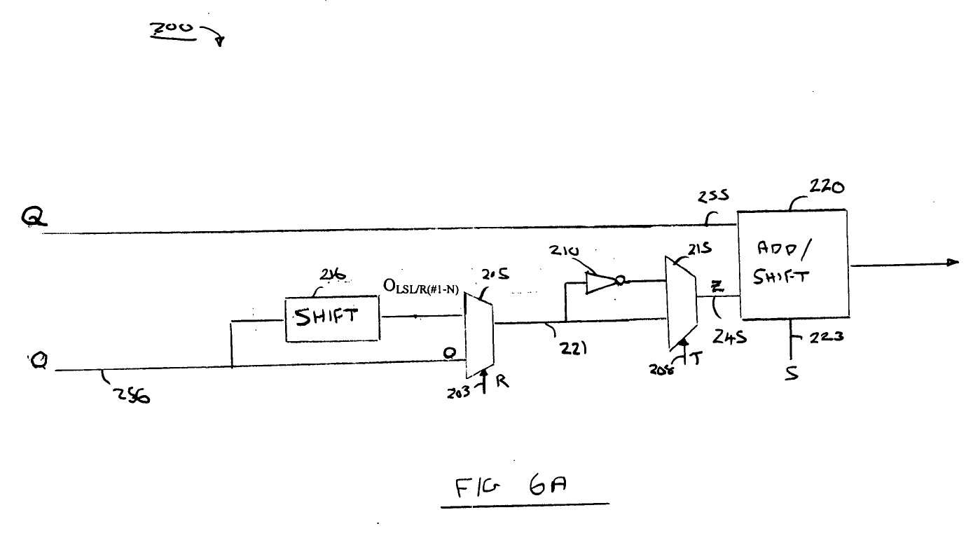

### DESCRIPTION OF A PREFERRED EMBODIMENT

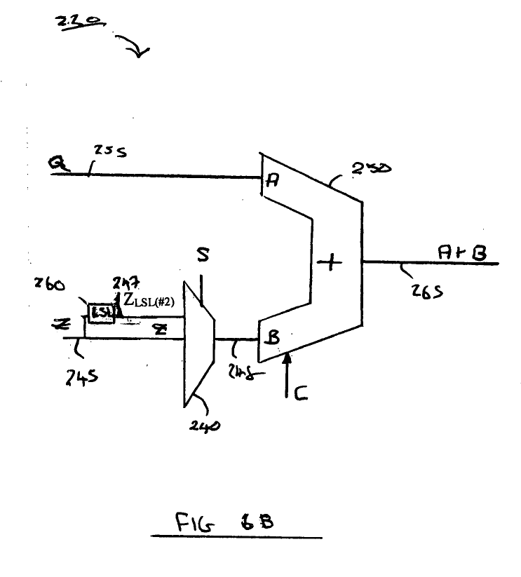

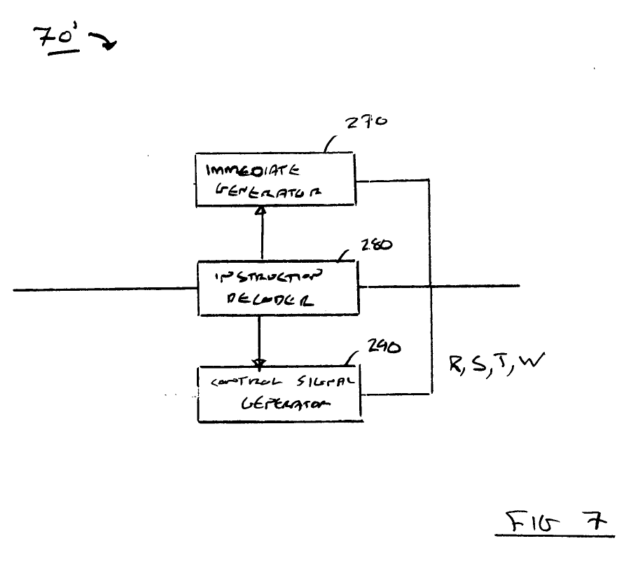

FIGS. 6A and 6B illustrate the arrangement of elements of an address generation stage 200 of a pipelined processor in accordance with an embodiment of the present invention. The address generation stage 200 is optimised to handle the most commonly occurring instructions (i.e. addition operations with or without a particular predetermined shift operation) in a minimal time, whilst more infrequently occurring instructions (i.e. those requiring the generation of a negative operand and/or all other shift operations) take longer to process. By optimising the address generation stage 200 to handle the most commonly occurring instructions more quickly than those which occur less frequently, the overall performance of the address generation stage 200 is improved.

The reason why the generation of a negative operand occurs infrequently can be explained as follows. The address generation stage 200 is required to generate addresses of data values to be accessed from locations in a memory in the course of the processor executing an instruction. It is common practice when addressing memory to define a base address and then to access other addresses which are offset from that base address.

When accessing memory in this way it is very common to generate an instruction which results in an address being generated in the form of address Q plus some offset O (which may be a number of bytes or words) to access a location a number of bytes or words incremented from the base address. Equally, it is very common to generate an instruction which results in an address being generated in the form of address Q plus some offset O (which may be a number of bytes or words) multiplied by P (which is a positive integer), also to access a location a number of bytes or words incremented from the base address. However, it is very uncommon when accessing memory in this way to generate an instruction which results in an address being generated in the form of address Q minus some offset O (which may be a number of bytes or words) to access a location a number of bytes or words decremented from the base address. Equally, it is very uncommon to generate an instruction which results in an address being generated in the form of address Q minus some offset O (which may be a number of bytes or words) multiplied by P (which is a positive integer), also to access a location a number of bytes or words decremented from the base address. This is because it would be normal practice instead to simply change the location of the base address.

As shown in FIG. 6A, the address generation stage 200 includes address generation logic 220 (which is arranged to selectively add together operands as well as to perform one predetermined shift operation, as will be described in more detail below), inversion logic 210 (which is arranged to generate an inverse or negative or complementary representation of an operand), shift logic 216 (which is arranged to perform every possible shift operation) and routing logic in the form of multiplexers 205 and 215.

The address generation stage 200 receives operands associated with the instruction to be processed. In this arrangement, the operand Q representing the base address is provided directly to the address generation logic 220 over the path 255, whilst the operand O representing the offset is provided over the path 256. The shift logic 216 operates to provide any required shift operation on the offset operand and to provide that shifted operand to the multiplexer 205. The inversion logic 210 operates to provide an inverted representation of the operand output by the multiplexer 205 and to provide that inverted operand to the multiplexer 215. Accordingly, it will be appreciated that the operand representing the offset can be routed as appropriate by the multiplexers 205 and 215 for manipulation prior to being provided to the address generation logic 220.

The operation of the logic which manipulates the offset operand prior to being provided to the address generation logic 200 will now be explained in more detail. The multiplexer 205 receives a routing signal R over path 203, the multiplexer 215 receives a routing signal T over path 208. The routing signals R and T are generated by decode logic in a decode stage earlier in the pipeline, as will be described in more detail below.

The routing signals R and T are generated in dependence on the instruction being processed. The multiplexer 205 is controlled using the routing signal R and operates to select between the offset operand itself or a shifted offset operand provided by shift logic 216 (the shift operation performed by the shift logic 216 will be selected in dependence on the instruction associated with the operands) and to provide that selected operand on the path 221. The multiplexer 215 is controlled using the routing signal T and operates to select between the selected operand provided on the path 221 or an inverted representation of the selected operand provided by the inversion logic 210 and to provide that operand on the path 245 to the address generation logic 220.

Hence, instructions which require the generation of an inverse operand and/or a shift operation other than the shift operation which can be performed by the address generation logic 220 cause the routing signals R and/or T to be generated which causes the multiplexers 205 and 215 to select the appropriately manipulated operand.

Instructions which do not require the generation of a negative operand, or which require a shift operation which can be performed by the address generation logic 220, or which do not require any shift operation at all cause the routing signals R and T to be generated which causes the multiplexers 205 and 215 to supply the offset operand directly to address generation logic 220. The decode logic supplies the routing signals R and T to the multiplexers 205 and 215 at the appropriate time, to coincide with the instruction reaching the address generation stage 200.

As mentioned above, instructions which require the generation of an inverse operand (also known as a subtrahend operand; it will be appreciated that in the statement: t−u=v, the terms t, u and v are referred to as the minuend, subtrahend and difference operands respectively) cause routing signal T to be generated which causes the multiplexer 215 to select the operand which has been routed through the inversion logic 210.

Also, as mentioned above, instructions which require the generation of a shift operation other than the shift operation which can be performed by the address generation logic 220 cause the routing signal R to be generated which causes the multiplexer 205 to select the operand which had been routed through the shift logic 216. The shift logic 216 receives the operand and generates a shifted operand from the received operand. The shifted operand may be the operand logically shifted left or right by any number of bits. In this embodiment, each operand is 32-bits. Accordingly, the shift logic 216 is operable to generate a shifted operand which is logically shifted between 1 and 31 bits left or right. The decode logic supplies the routing signals R and T to the multiplexers 203 and 208 respectively at the appropriate time, to coincide with the instruction reaching the address generation stage 200.

Instructions which require the generation of an inverse shifted operand cause routing signals R and T to be generated which causes firstly a shifted operand to be selected, as outline above, and then the inverted representation of the shifted operand to be selected. The decode logic supplies the routing signals R and T to the multiplexers 203 and 208 at the appropriate times, to coincide with the instruction reaching the address generation stage 220.

Hence, the address generation logic 220 receives either the original operands associated with the instruction or, where appropriate, operands which have been manipulated by the shift logic 216 and/or the inversion logic 210. With reference to FIG. 6B, any operand which is to be the subject of a shift operation supported by the address generation logic 220 is provided on the bus 245, the remaining operand is provided on the bus 255.

The operand provided on the bus 245 is provided directly to one input of a two input multiplexer 240. The operand provided on the bus 245 is also subject to a predetermined logical shift left operation by interconnect logic 260. Whilst in this embodiment the predetermined shift operation is a logical shift left by 2 bits operation (this has been found to be the most frequently-occurring shift operation), it will be appreciated that any particular shift operation could have been selected. The interconnect logic 260 is arranged to reorder the bits provided on the bus 245 to effect the logical shift operation and to provide these reordered bits to the second input of the multiplexer 240.

Accordingly, it will be appreciated that where the operand provided on the bus 245 is, for example, Z, then Z and Z_{LSL(#2)} are provided to the multiplexer 240. Conversely, where the operand provided on the bus 245 is, for example, \overline{Z}, then \overline{Z} and \overline{Z_{LSL(#2)}} are provided to the multiplexer 240.

The multiplexer 240 receives a selection signal S from the decode logic, as will be described in more detail below. The selection signal S is generated in dependence on the instruction. Instructions which require the generation of the particular shifted operand cause a selection signal S to be generated with causes the multiplexer 240 to supply the shifted operand to an adder 250. Instructions which do not require the generation of the shifted operand cause a selection signal S to be generated with causes the multiplexer 240 to supply the received operand to the adder 250. The decode logic supplies the selection signal S to the multiplexer 240 at the appropriate time, to coincide with the instruction reaching the address generation stage 200.

The adder 250 then combines the operands received over the buses 255 and 248 to generate an address which is provided on a bus 265 for subsequent use by the pipeline stages.

FIG. 7 illustrates elements of a decode stage 70′ which includes the decode logic. The decode stage 70′ comprises an immediate generator 270, an instruction decoder 280 and a control signal generator 290.

The instruction decoder 280 is arranged to decode instructions and to provide information and signals to enable that instruction to be processed by subsequent stages in the pipeline.

On receipt of an instruction which requires the supply of an immediate or constant, the instruction decoder 280 activates an immediate generator 270 which produces the immediate in the required form in parallel with the operation of the instruction decoder 280. It is possible to generate immediates in positive or negative form in parallel with the instruction decoding without increasing the time taken by the decode stage 70′. That immediate may then flow through the pipeline with the other signals generated by the decode stage 70′ or may be provided over a dedicated bus.

The instruction decoder 280 also when decoding an instruction activates a control signal generator which provides various control signals to subsequent stages of the pipeline in dependence on that instruction. Three such control signals are the selection signal S and the routing signals R and T. These signals may flow through the pipeline with the other signals generated by the decode stage 70 or may be provided over dedicated paths and are timed to coincide with the processing of this instruction at particular stages in the pipeline.

When the instruction to be processed involves subtracting a subtrahend operand in the form of an immediate from a minuend operand, the immediate generator 270 may be arranged to generate a negative or inverse immediate and provide this negative immediate to the address generation stage 170. Because the immediate is already in negative form, there is no need to invoke the inversion logic 210 and instead the instruction can be dealt with as if it were an additive instruction. Accordingly, the control signal generator 290 generates a selection signal S and routing signals R and T to control the selection and routing of the operands as if they related to an additive instruction. Hence, instructions utilising negative immediates can be treated as additive instructions and the negative immediate can be routed directly to the address generation logic 220. It will be appreciated that this further improves the performance of the address generation stage 200.

It will be appreciated that through the approach described above, the address generation stage 200 is optimised to handle the most frequently encountered operations. Accordingly, addition operations with or without a particular shift operation are processed as quickly as possible, whilst some subtraction operations and/or other shift operations require longer to process. Because the subtraction operations and the other shift operations occur relatively less frequently than addition operations and the particular shift operation, the overall performance of the address generation stage 200 is significantly improved.

Although a particular embodiment has been described herein, it will be apparent that the invention is not limited thereto, and that many modifications and additions thereto may be made within the scope of the invention. For example, various combinations of the features of the following dependent claims can be made with the features of the independent claims without departing from the scope of the present invention.

1. A data processing apparatus comprising:
a processor core operable to process a sequence of instructions, said processor core having a plurality of pipeline stages, one of said plurality of pipeline stages being an address generation stage operable to generate an address associated with an instruction for subsequent processing by said pipeline stages, said instruction being one from a first group of instructions or a second group of instructions, said address generation stage comprising:
address generation logic operable to receive operands associated with said instruction, to generate a shifted operand from one of said operands, and to add together, in dependence on said instruction, selected of said operands and said shifted operand to generate said address for subsequent processing by said pipeline stages; and
operand routing logic operable, in dependence on said instruction, to route operands associated with instructions from said first group of instructions to said address generation logic and to route operands associated with instructions from said second group of instructions via operand manipulation logic for manipulation of said operands prior to routing to said address generation logic.

2. The data processing apparatus of claim 1, wherein said instruction relates to a memory access and said address indicates a location in memory to be accessed.

3. The data processing apparatus of claim 1, wherein said first group of instructions comprises a first instruction which causes the processor core to logically add together two operands, and a second instruction which causes the processor core to logically add together one operand to another operand logically shifted by one of a predetermined number of bits.

4. The data processing apparatus of claim 3, wherein said address generation logic is operable to generate said another operand logically shifted by one of a predetermined number of bits.

5. The data processing apparatus of claim 3, wherein said second instruction causes the processor core to logically add together one operand to another operand logically shifted left by two bits.

6. The data processing apparatus of claim 5, wherein said address generation logic is operable to generate said another operand logically shifted left by two bits.

7. The data processing apparatus of claim 3, wherein said second instruction causes the processor core to logically add together one operand to another operand subject to only one preset logical shift operation.

8. The data processing apparatus of claim 1, wherein said address generation logic is operable to perform only one predetermined logical shift operation and operands associated with all other logical shift operations required by instructions from said second group of instructions are routed via operand manipulation logic for manipulation of operands prior to routing to said address generation logic.

9. The data processing apparatus of claim 3, wherein said second group of instructions comprises instructions which cause the processor core to logically add together one operand to another operand subject to any other logical shift operation.

10. The data processing apparatus of claim 9, wherein said operand manipulation logic is operable, in dependence on said instruction, to generate said another operand logically shifted by any other number of bits.

11. The data processing apparatus of claim 1, wherein said second group of instructions comprises instructions which cause the processor core to logically subtract one operand from another operand.

12. The data processing apparatus of claim 11, wherein said operand manipulation logic is operable, in dependence on said instruction, to generate an inverse representation of one of said operand and said another operand.

13. The data processing apparatus of claim 1, wherein said second group of instructions comprises a subtractive instruction for which said address is generated by subtracting a subtrahend operand from a minuend operand associated with said instruction, and said operand manipulation logic comprises subtraction operand generation logic operable to generate a negative representation of said subtrahend operand prior to routing to said address generation logic.

14. The data processing apparatus of claim 1, wherein said address generation logic comprises:
operand generation logic operable to receive a first operand associated with said instruction and to generate a shifted operand representative of said first operand shifted by a predetermined number of bits;
operand selection logic operable, in dependence on said instruction, to select one of said first operand and said shifted operand as a selected operand; and
addition logic operable to add a second operand associated with said instruction to said selected operand to generate said address for subsequent processing by said pipelined stages.

15. The data processing apparatus of claim 14, wherein said first operand comprises ‘n’-bits, where ‘n’ is a positive integer, said operand generation logic receives said first operand over an ‘n’-bit input bus and provides said shifted operand on an ‘n’-bit output bus, said operand generation logic comprising:
interconnection logic operable to couple lines of the ‘n’-bit input bus with lines of the ‘n’-bit output bus to perform the shift operation.

16. The data processing apparatus of claim 14, wherein said operand selection logic is a two-input multiplexer.

17. The data processing apparatus of claim 14, wherein said operand selection logic is operable to select one of said first operand and said shifted operand as a selected operand in response to a selection signal generated by instruction decoder logic.

18. The data processing apparatus of claim 14, wherein said addition logic is a two-operand adder.

19. The data processing apparatus of claim 1, wherein said operand routing logic is operable to route operands in response to a routing signal generated by instruction decoder logic.

20. The data processing apparatus of claim 1, wherein said instruction is a subtraction instruction which causes the processor core to generate said address by subtracting a subtrahend operand in the form of an immediate from a minuend operand, and said data processing apparatus comprises instruction decoder logic operable to provide said subtrahend operand in negative form to said address generation stage and to generate a routing signal to cause said operand routing logic to route operands to said address generation logic.

21. The data processing apparatus of claim 1, wherein said instruction is one of a load instruction and a store instruction.

22. In a data processing apparatus comprising a processor core operable to process a sequence of instructions, said processor core having a plurality of pipeline stages, one of said plurality of pipeline stages being an address generation stage operable to generate an address associated with an instruction for subsequent processing by said pipeline stages, said instruction being one from a first group of instructions or a second group of instructions, a method of generating said address comprising the steps of:
a) receiving, at address generation logic, operands associated with said instruction;
b) generating a shifted operand from one of said operands;
c) adding together, in dependence on said instruction, selected of said operands and said shifted operand to generate said address for subsequent processing by said pipeline stages;
d) routing, in dependence on said instruction, operands associated with instructions from said first group of instructions to said address generation logic; and
e) routing, in dependence on said instruction, operands associated with instructions from said second group of instructions via operand manipulation logic for manipulation of said operands prior to routing to said address generation logic.

23. The method of claim 22, wherein said instruction relates to a memory access and said address indicates a location in memory to be accessed.

24. The method of claim 22, wherein said first group of instructions comprises a first instruction which causes the processor core to logically add together two operands, and a second instruction which causes the processor core to logically add together one operand to another operand logically shifted by one of a predetermined number of bits.

25. The method of claim 24, wherein said step (b) comprises generating said another operand logically shifted by one of a predetermined number of bits.

26. The method of claim 24, wherein said second instruction causes the processor core to logically add together one operand to another operand logically shifted left by two bits.

27. The method of claim 26, wherein said step (b) comprises generating said another operand logically shifted left by two bits.

28. The method of claim 24, wherein said second instruction causes the processor core to logically add together one operand to another operand subject to only one preset logical shift operation.

29. The method of claim 22, wherein said address generation logic is operable to perform only one predetermined logical shift operation.

30. The method of claim 24, wherein said second group of instructions comprise instructions which cause the processor core to logically add together one operand to another operand subject to any other logical shift operation.

31. The method of claim 30, wherein said operand manipulation logic is operable, in dependence on said instruction, to generate said another operand logically shifted by any other number of bits.

32. The method of claim 22, wherein said second group of instructions comprises instructions which cause the processor core to logically subtract one operand from another operand.

33. The method of claim 32, wherein said operand manipulation logic is operable, in dependence on said instruction, to generate an inverse representation of one of said operand and said another operand.

34. The method of claim 22, wherein said second group of instructions comprises a subtractive instruction for which said address is generated by subtracting a subtrahend operand from a minuend operand associated with said instruction, and said operand manipulation logic comprises subtraction operand generation logic operable to generate a negative representation of said subtrahend operand prior to routing to said address generation logic.

35. The method of claim 1, wherein said step (a) comprises the step of receiving a first operand associated with said instruction, said step (b) comprises the step of generating a shifted operand representative of said first operand shifted by a predetermined number of bits and said step (c) comprises the steps of: selecting one of said first operand and said shifted operand as a selected operand; and adding a second operand associated with said instruction to said selected operand to generate said address for subsequent processing by said pipelined stages.

36. The method of claim 35, wherein said first operand comprises ‘n’-bits, where ‘n’ is a positive integer, said step (a) comprises receiving said first operand over an ‘n’-bit input bus and said step (b) comprises providing said shifted operand on an ‘n’-bit output bus by providing interconnection logic operable to couple lines of the ‘n’-bit input bus with lines of the ‘n’-bit output bus to perform the shift operation.

37. The method of claim 35, wherein said selecting step is performed by a two-input multiplexer.

38. The method of claim 35, wherein said selecting step comprises selecting one of said first operand and said shifted operand as a selected operand in response to a selection signal generated by instruction decoder logic.

39. The method of claim 35, wherein said addition step is performed by a two-operand adder.

40. The method of claim 22, wherein said steps (d) and (e) comprise routing operands in response to a routing signal generated by instruction decoder logic.

41. The method of claim 22, wherein said instruction is a subtraction instruction which causes the processor core to generate said address by subtracting a subtrahend operand in the form of an immediate from a minuend operand, and said data processing apparatus comprises instruction decoder logic operable to provide said subtrahend operand in negative form to said address generation stage and to generate a routing signal to cause said operands to be routed to said address generation logic.

42. The method of claim 22, wherein said instruction is one of a load instruction and a store instruction.
